(19) United States
(12) Patent Application Publication
(10) Pub. No.: US 2009/0140204 A1
(43) Pub. Date: Jun. 4, 2009

(54) Precursor compound and crystallised compound of the alkaline-earth aluminate type, and methods of preparing and using the crystallised compound as phosphor

(76) Inventor: Thierry Le-Mercier, Rosny-Sous-Bois (FR)

Correspondence Address: BUCHANAN, INGERSOLL & ROONEY PC, POST OFFICE BOX 1404, ALEXANDRIA, VA, 22313-1404, US

(21) Appl. No.: 11/666,517

(22) PCT Filed: Nov. 4, 2005
(86) PCT No.: PCT/FR05/02752

§ 371 Date: Apr. 27, 2007

(30) Foreign Application Priority Data
Nov. 10, 2004 (FR) 0411980

(51) Int. Cl. C09K 11/54; C09K 11/64; C09K 11/62; C09K 11/66

(52) U.S. Cl. 252/301.6 R; 252/301.4 R; 252/301.4 F

(57) ABSTRACT

The invention relates to an alkaline-earth-aluminate-type compound which is at least partially crystallised such as in the form of a beta- or tridymite-type alumina Said compound can be used as phosphor in plasma-type screens or in trichromatic lamps, backlights for liquid crystal displays or plasma excitation lighting or in light-emitting diodes. The invention also relates to a precursor compound of the aforementioned compound.

The present invention relates to a precursor compound of an alkaline-earth metal aluminate, a crystallized compound of the alkaline-earth metal aluminate type, their preparation methods and use of the crystallized compound as a phosphor.

Many manufactured products incorporate phosphors in their manufacture. These phosphors may emit a light whose color and intensity are functions of the excitation that they are undergoing. They are thus widely used, for example, in plasma display screens or in trichromatic lamps.

As an example of this type of phosphor, mention may be made of barium magnesium aluminate doped with divalent europium of formula BaMgAl₁₀O₁₇:Eu²⁺ (BAM). This is a phosphor that has particularly advantageous properties as, in particular, it has an excitation spectrum that covers the whole of the UV and VUV range with a very high quantum efficiency and it gives an emission color that is perfectly blue and saturated.

Its use, and more generally that of phosphors of this type, in the systems described above still have one major drawback, which is instability during the manufacture of these systems. This is because the phosphors are deposited via an organic polymer during a coating step.

The removal of this organic portion is carried out at high temperature, between 400 and 650° C., in air. This heat treatment (baking) degrades the photoluminescence efficiency by more than 30% due, especially, to the oxidation of divalent europium to trivalent europium.

This degradation is even more pronounced when the size of the particles that make up the phosphor is small.

This degradation problem is also encountered during the operation of plasma display screens. This is because the very high energy VUV radiation causes a photon reaction with the matrix of the phosphor, aluminate for example, which, in particular, constantly reduces the photoluminescence efficiency and displaces the emission toward the green.

There is therefore a need for phosphors that have an improved resistance to the heat treatment during their processing in the manufacture of electronic systems or else an improved usage resistance, while these systems are being used.

One subject of the invention is to provide such products.

Another subject of the invention is to obtain the precursors of these products.

With this aim, the compound of the invention is a compound of the alkaline-earth metal aluminate type, at least partially crystallized in the form of a β-type alumina, characterized in that it has a composition corresponding to the formula:

a(M¹O).b(MgO).c(Al₂O₃) (1)

in which M¹ denotes at least one alkaline-earth metal and a, b and c are integers or nonintegers satisfying the relationships:

0.25≧a≧4; 0≦b≦2 and 0.5≦c≦9;

in that M¹ is partially substituted with europium and at least one other element belonging to the group of rare-earth elements whose ionic radius is less than that of Eu³⁺ and in that it is in the form of substantially whole particles with an average size of at most 6 μm.

The invention also relates to an alkaline-earth metal aluminate precursor, characterized in that it has a composition corresponding to the formula:

a(M¹O).b(MgO).c(Al₂O₃) (1)

in which M¹ denotes at least one alkaline-earth metal and a, b and c are integers or nonintegers satisfying the relationships:

0.25≦a≦4; 0≦b≦2 and 0.5≦c≦9;

in that M¹ is partially substituted with europium and at least one other element belonging to the group of rare earth elements whose ionic radius is less than that of Eu³⁺ and in that it is in the form of particles with an average size of at most 15 μm.

The invention also relates to a method for preparing a precursor compound as defined above that is characterized in that it comprises the following steps:
forming a liquid mixture consisting of the aluminum, M¹ and magnesium compounds and the compounds of their substituents;
drying said mixture by spray drying; and
calcining the dried product at a temperature of at most 950° C.

Finally, the method for preparing the crystallized compound of the alkaline-earth metal aluminate type mentioned above is, according to the invention, characterized in that it comprises the same steps as those described previously and, in addition, an extra step in which the product resulting from the first calcination is calcined again at a high enough temperature to produce the tridymite-, β-, magnetoplumbite- or garnet-type alumina structure and/or luminescence properties for said compound.

The crystallized compounds of the invention have an improved resistance to heat treatments and/or an improved resistance during operation. Under certain conditions, it is even possible to observe no degradation of their luminescence property after the heat treatment (baking) or during operation. Finally, at least under certain excitation conditions, especially under UV or VUV, their luminescence, by itself and independently of its better degradation resistance, may also be greater than those of the products of the prior art.

Other features, details and advantages of the invention will become even more clearly apparent on reading the following description, given with reference to the appended drawings in which:

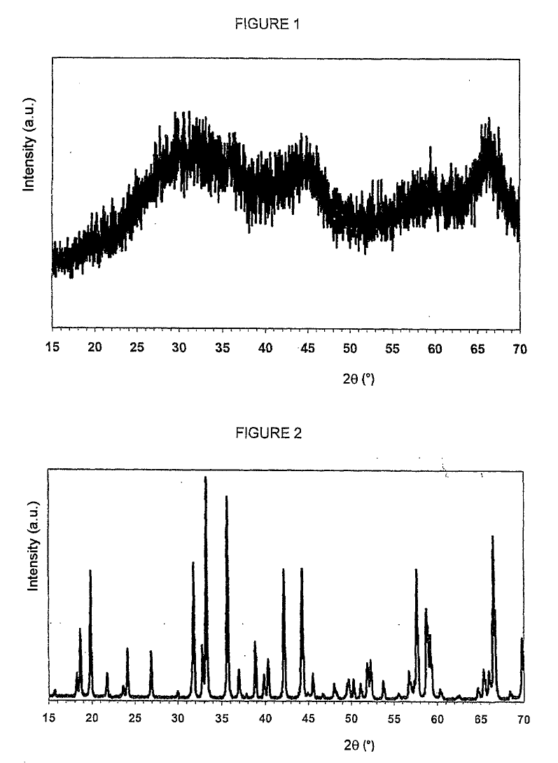

FIG. 1 is an X-ray diagram of a precursor compound according to the invention;

FIG. 2 is an X-ray diagram of an aluminate obtained by calcining a precursor compound according to the invention;

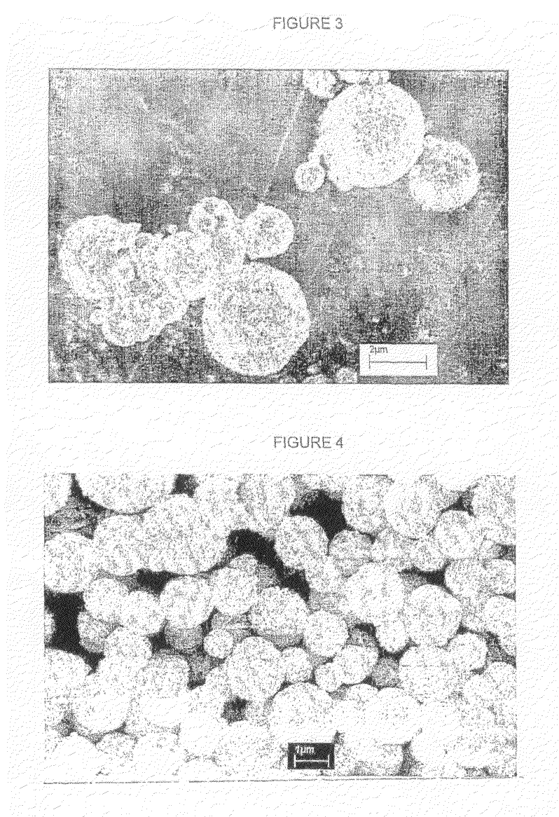

FIG. 3 is a scanning electron microscopy (SEM) photograph of a precursor compound of the invention; and

FIG. 4 is a scanning electron microscopy (SEM) photograph of an aluminate compound according to the invention.

The invention relates to two types of products, one which may have, especially, luminescence properties, a compound which will be referred to in the rest of the description as “aluminate compound”, the other which may be considered as a precursor of alkaline-earth metal aluminate type crystallized compounds and especially as a precursor of the aluminate compound of the invention, and which will be referred to in the rest of the description as “precursor compound” or “precursor”. These two products will now be described successively.

The aluminate compound of the invention has a composition which is given by the formula (1) above. The alkaline-earth metal may more particularly be barium, calcium or strontium, the invention more particularly applying to the case where M¹ is barium and also to the case where M¹ is barium in combination with strontium in any proportion but which may be, for example, at most 30% of strontium, this proportion being expressed by the atomic percentage ratio SR/(Ba+Sr).

According to one essential feature of the invention, the element M¹ is partially substituted with at least two substituent elements. It is important to note here that the present description is made under the hypothesis that corresponds to the present knowledge of the Applicant, that is to say that the aforementioned substituent elements are indeed substitutions of M¹, but the description should not be interpreted in a limited manner based on this hypothesis. This implies that it would not be outside the scope of the present invention if the substituents described for the element M¹ proved in fact to be substituents of a constituent element other than the one presumed in the present description. The essential feature is the presence of the aforementioned elements presented as substituents in the compound.

With regard now to the nature of these substituents, one of these is europium. The other substituent or substituents are chosen from the group of rare earth elements whose ionic radius is less than that of Eu³⁺. In order to determine the ionic radius, reference can be made to the article by R. D. Shannon, Acta Crystallogr. Sect A 32, 751 (1976). This group in fact contains the rare earth elements having an atomic number greater than that of europium and therefore it contains the following elements: gadolinium, terbium, dysprosium, holmium, erbium, thulium, ytterbium and lutetium. Yttrium and scandium also belong to this group.

According to a preferred embodiment, the second substituent element is chosen from gadolinium, terbium, ytterbium or yttrium and most particularly, it may be ytterbium or yttrium and also the combination of the latter two elements.

The amounts of these substituents may vary, in a known manner, within wide ranges. The minimum amount of substituents is that below which the substituents no longer produce an effect. Thus, europium must preferably be present in a sufficient amount so that this element may give the compound suitable luminescence properties. Furthermore, the amount of the second substituent is also fixed by the heat treatment resistance threshold that it is desired to obtain. For the maximum values, it may be preferable to stay below the amount above which it is no longer possible to obtain compounds that are in the pure phase, for example that are in the form of a pure β-alumina.

In general, the amount of europium and of the other aforementioned element may be at most 30%, this amount being expressed by the atomic ratio (Eu+other element)/(M¹+Eu+other element) as a percentage. It may also more particularly be at least 1%. It may, for example, be between 5% and 20%, more particularly between 5% and 15%.

Also in general, the amount of the other substituent element (element other than europium) is at most 50%, more particularly at most 30%, this amount being expressed by the atomic ratio other element/Eu as a percentage. This quantity may be at least 1%, more particularly at least 2% and even more particularly at least 5%.

Still regarding the possible substitutions, it will be noted that magnesium may also be partially substituted with at least one element chosen from zinc, manganese or cobalt. Finally, the aluminum may optionally be partially substituted with at least one element chosen from gallium, scandium, boron, germanium or silicon. The comments that were made above on the M¹ substituents, as regards the interpretation of the term substituent and as regards the amounts, also apply here.

Generally, the amount of the magnesium substituent is at most 50%, more particularly at most 40% and even more particularly at most 10%, this amount being expressed in atomic percent (substituent/(substituent+Mg) atomic ratio). These proportions apply most particularly to the case where the substituent is manganese. For aluminum, this amount, expressed in the same way, is generally at most 15%. The minimum amount of substituent may be at least 0.1% for example.

As more particular compounds of the invention, mention may be made of those that correspond to the formula (1) in which b>0 and also those of formula (1) in which a, b and c satisfy the relationships: 0.25≦a≦2; 0<b≦2 and 3≦c≦9. For these compounds, M¹ may more particularly be barium.

Mention may also be made of those that correspond to the formula (1) in which a=b=1 and c=5 or 7, M¹ may more particularly denote barium. As examples of compounds of this type, mention may be made of: Ba_{0.9}M²_{0.1}MgAl₁₀O₁₇; Ba_{0.9}M²_{0.1}Mg_{0.8}Mn_{0.2}Al₁₀O₁₇; Ba_{0.9}M²_{0.1}MgAl₁₄O₂₃, Ba_{0.9}M²_{0.1}Mg_{0.95}Mn_{0.05}Al₁₀O₁₇, Ba_{0.9}M²_{0.1}Mg_{0.6}Mn_{0.4}Al₁₀O₁₇, M² denoting here and for the remainder of the description the europium/other rare-earth element substituent combination.

Mention may also be made of those that correspond to the formula (1) in which a=1, b=2 and c=8, M¹ may more particularly denote barium, especially Ba_{0.8}M²_{0.2}Mg_{1.93}Mn_{0.07}Al₁₆O₂₇.

Another important feature of the aluminate compound is that it is in the form of fine particles, that is to say having an average size or an average diameter of at most 6 μm. This average diameter (as defined below) may more particularly be between 1.5 μm and 6 μm, and even more particularly between 1.5 μm and 5 μm.

The particle size distribution of the aluminate compound particles of the invention may also be narrow. Thus, the dispersion index σ/m may be at most 0.7. It may more particularly be at most 0.6.

The term “dispersion index” is understood to mean the ratio:

σ/m=(d₈₄−d₁₆)2d₅₀

in which:
d₈₄ is the particle diameter for which 84% of the volume of the population of said particles is formed from particles having a diameter of less than this value;
d₁₆ is the particle diameter for which 16% of the volume of the population of said particles is formed from particles having a diameter of less than this value; and
d₅₀ is the particle diameter for which 50% of the volume of the population of said particles is formed from particles having a diameter of less than this value.

Throughout the description, the average size and the dispersion index are values obtained by employing the laser diffraction technique and using a Coulter particle size analyzer.

According to one particular embodiment, these particles are substantially spherical.

According to another particular embodiment, these particles are in the form of hexagonal platelets.

These morphologies may be demonstrated by scanning electron microscopy (SEM).

In these two embodiments, the particles are well separated and individualized. There are no, or very few, particle agglomerates.

Another specific feature of the aluminate compound is that it is in the form of substantially whole particles. The term “whole particle” is understood to mean a particle that has not been broken or crushed as is the case during grinding. The scanning electron microscopy photographs make it possible to distinguish crushed particles from particles that have not been crushed. Thus the spheres or the platelets formed by the particles indeed appear substantially whole. These photographs do not show the presence of residual fine particles stemming from grinding. This feature of substantially whole particles may also be checked indirectly by the heat treatment resistance properties of the product. This resistance is improved relative to that of a product of the same composition but whose particles have been ground.

The aluminate compound of the invention has, as another feature, a crystallized structure in the form of a tridymite-, β-, magnetoplumbite- or garnet-type alumina. This structure depends on the composition of the aluminate compound. Thus, in the case where b=0, this compound is a tridymite structure.

The term “β-type alumina” is understood to mean, here and throughout the description, not only the β-alumina phase but also the β′ and β″ derived phases.

The crystalline structure of the compound is demonstrated by X-ray analysis. It will be noted that the aluminate compound is at least partially crystallized in the form of an alumina of the type given above, especially of the β-type, which means that it is not excluded that the aluminate compound may be in the form of a mixture of crystalline phases.

According to another particular embodiment, the aluminate compound is in the form of a pure alumina phase, of β or tridymite type in particular. The term “pure” is understood to mean that the X-ray analysis only shows a single phase and does not make it possible to detect the presence of phases other than the alumina phase of the type in question.

The aluminate compound of the invention may have a certain number of additional features.

Thus, another feature of this aluminate compound is its nitrogen purity. The nitrogen content of this compound may be at most 1%, this amount being expressed by weight of nitrogen relative to the total weight of the compound. This amount may more particularly be at most 0.6%. The nitrogen content is measured by melting a sample in a resistance heating oven and measuring the thermal conductivity.

According to other embodiments, the aluminate compound of the invention may also have a high purity in terms of other elements.

Thus, it may have a carbon content of at most 0.5%, more particularly at most 0.2%. It may also have, according to another embodiment, a chlorine content of at most 10%, more particularly at most 5%.

Finally, it may also have a sulfur content of at most 0.05%, more particularly at most 0.01%.

The carbon content and the sulfur content are measured by combustion of a sample in a resistance heating furnace and by detection using an infrared system. The chlorine content is measured by the X-ray fluorescence technique.

For the values given above, the contents are all expressed in percentage by weight of the element in question relative to the total weight of the compound. Of course, the aluminate compound of the invention, apart from the nitrogen content given above, may have at the same time the abovementioned carbon, chlorine and sulfur contents.

The invention also relates to a precursor compound that will now be described.

This compound has identical features to that of the aluminate compound as regards the composition, the substitution elements of M¹, Mg and Al and their amounts and the purity in terms of nitrogen, carbon, chlorine and sulfur elements. Consequently, the whole of the description that was given above for the aluminate compound applies in the same way here for the precursor and for these characteristics.

On the other hand, the precursor may have features different from those of the aluminate compound as regards firstly the size, the precursor compound may be in a larger size range than the aluminate compound.

Thus, the particles which form the precursor have an average size or average diameter (as defined above) that is at most 15 μm, more particularly at most 10 μm and even more particularly at most 6 μm. This average diameter may more particularly be between 1.5 μm and 6 μm and even more particularly between 1.5 μm and 5 μm. Of course, a product having a particle size of at most 6 μm will preferably be used as the precursor of the aluminate compound of the invention.

These particles have, in addition, the same dispersion index values as those that were given above for the aluminate compound.

The particles of the precursor compound of the invention are generally substantially spherical. Furthermore, the spheres that form these particles are generally solid. This feature may be demonstrated by transmission electron microscopy (TEM) microtomy.

In addition, these particles have a specific porosity. This is because they comprise pores whose average diameter is at least 10 nm. This diameter may more particularly be between 10 nm and 200 nm, and even more particularly between 10 nm and 100 nm. This porosity is measured by the known nitrogen and mercury techniques.

The precursor may be crystallized essentially in the form of a transition alumina that may be, for example, of γ-type. This crystallization is demonstrated by X-ray analysis. The term “essentially” is understood to mean that the X-ray diagram may have, apart from the predominant transition alumina phase, one or more minor phases corresponding to impurities.

According to a preferred embodiment of the invention, the X-ray diagram shows that only the transition alumina phase is present.

The precursor compound of the invention may, in addition, be characterized by its calcination behavior. Thus, its crystallographic structure changes as a result of a calcination. Generally, its transition alumina structure is transformed into another structure at a relatively low temperature, this structure and this temperature both being dependent on the composition of the precursor of the invention.

Thus, in the particular case of magnesium aluminate precursors of formula (1) where the alkaline-earth metal is barium and for which a=b=1 and c=5 or 7 or for which a=1, b=2 and c=8, and also precursors of formula (1) in which a, b and c satisfy the relationships: 0.25≦a≦2; 0<b≦2 and 3≦c≦9, for example the aforementioned products of formula Ba_{0.9}M²_{0.1}MgAl₁₀O₁₇; Ba_{0.9}M²_{0.1}Mg_{0.8}Mn_{0.2}Al₁₀O₁₇; Ba_{0.9}M²_{0.1}MgAl₁₄O₂₃, Ba_{0.9}M²_{0.1}Mg_{0.95}Mn_{0.05}Al₁₀O₁₇, Ba_{0.9}M²_{0.1}Mg_{0.6}Mn_{0.4}Al₁₀O₁₇, the products resulting from the calcination have a structure at least partially in the form of a β-alumina or a derivative thereof.

As indicated above, the aluminates resulting from the precursor compounds of the invention may be in the form of a pure crystallographic phase and this pure phase, in the case of β-type alumina, is obtained at a temperature of or around 1200° C.

The particles of the precursor of the invention are, in addition, chemically homogeneous. This is understood to mean that at least the constituent elements are not present in the compound in the form of a simple physical mixture, for example a mixture of oxides, but on the contrary there are chemical-type bonds between these elements.

Furthermore, this chemical homogeneity may be quantified by determining the size of the heterogeneity domains. These are less than 60 nm². This means that there is no difference in the chemical composition of the particles of the precursor of the invention between the regions with a surface area of 60 nm².

This homogeneity feature is determined by EDS-TEM analysis. More precisely, the heterogeneity domain is measured by the energy dispersion spectroscopy (EDS) method using a transmission electron microscopy (TEM) nanoprobe.

The precursor compound generally has a BET specific surface area of at least 75 m²/g, which may be between, for example, 75 m²/g and 200 m²/g.

Finally, the precursor may also be in the form of substantially whole particles, this expression having here the same meaning as for the aluminate compound.

As an advantageous property of the precursor of the invention, it is also found that, during the calcination, the compound of the invention may retain its spherical morphology. There is no sintering of these spherical particles among themselves. The dispersion index of the particles is also retained. Finally, the particle size various only slightly. The d₅₀ may for example increase by at most 2 μm or 1 μm.

The method for preparing the compounds of the invention will now be described.

As indicated above, this method comprises a first step in which a liquid mixture is formed that is a solution or a suspension or even a gel, of the aluminum compounds and the compounds of the other elements (M¹, magnesium and their substituents) incorporated in the composition of the precursor compound.

As compounds of these elements, inorganic salts or else hydroxides are normally used. As salts, mention may preferably be made of nitrates, especially for barium, aluminum, europium and magnesium. Sulfates, especially for aluminum, chlorides or else organic salts, for example acetates, may optionally be employed.

A colloidal dispersion or sol of aluminum may also be used as the aluminum compound. Such a colloidal aluminum dispersion may have particles or colloids whose size is between 1 nm and 300 nm. The aluminum may be present in the sol in boehmite form.

The following step consists in drying the previously prepared mixture. This drying is carried out by spray drying.

The term “spray drying” is understood to mean drying by spraying the mixture into a hot atmosphere. The spraying may be carried out using any sprayer known per se, for example a spray nozzle of the sprinkler-rose type or another type. It is also possible to use atomizers called turbine atomizers. With regard to the various spraying techniques that can be used in the present method, reference may especially be made to the fundamental work by Masters entitled “Spray Drying” (second edition, 1976, published by George Godwin, London).

It will be noted that it is also possible to employ the spray-drying operation by means of a “flash” reactor, for example of the type described in French patent applications Nos 2 257 326, 2 419 754 and European patent application 0 007 846. This type of spray dryer may be used in particular for preparing products of small particle size. In this case, the treating gases (hot gases) are given a helical motion and flow into a vortex well. The mixture to be dried is injected along a path coincident with the axis of symmetry of the helical paths of said gases, thereby allowing the momentum of the gases to be completely transferred to the mixture to be treated. In fact, the gases thus fulfill two functions: firstly, the function of spraying the initial mixture, that is to say converting it into fine droplets, and secondly, the function of drying the droplets obtained. Furthermore, the extremely short residence time (generally less than about 1/10th of a second) of the particles in the reactor has the advantage, among others, of limiting any risk of them being overheated as a result of being in contact with the hot gases for too lengthy a time.

With regard to the flash reactor mentioned above, reference may especially be made to FIG. 1 of European patent application 0 007 846.

This consists of a combustion chamber and a contact chamber composed of a double cone or a truncated cone whose upper part diverges. The combustion chamber runs into the contact chamber via a narrow passage.

The upper part of the combustion chamber is provided with an opening allowing the combustible phase to be introduced.

Moreover, the combustion chamber includes a coaxial internal cylinder, thus defining, inside the combustion chamber, a central region and an annular peripheral region, having perforations located mostly toward the upper part of the apparatus. The chamber has a minimum of six perforations distributed over at least one circle, but preferably over several circles which are spaced apart axially. The total surface area of the perforations located in the lower part of the chamber may be very small, of the order of 1/10th to 1/100th of the total surface area of the perforations of said coaxial internal cylinder.

The perforations are usually circular and of very small thickness. Preferably, the ratio of the perforation diameter to the wall thickness is at least 5, the minimum wall thickness being only limited by the mechanical requirements.

Finally, an angled pipe runs into the narrow passage, the end of which opens along the axis of the central region.

The gas phase undergoing a helical motion (hereinafter called the helical phase) consists of a gas, generally air, introduced into an orifice made in the annular region, this orifice preferably being located in the lower part of said region.

To obtain a helical phase in the narrow passage, the gas phase is preferably introduced at low pressure into the aforementioned orifice, that is to say at a pressure of less than 1 bar and more particularly at a pressure between 0.2 and 0.5 bar above the pressure existing in the contact chamber. The velocity of this helical phase is generally between 10 and 100 m/s and preferably between 30 and 60 m/s.

Furthermore, a combustible phase, which may especially be methane, is injected axially via the aforementioned opening into the central region at a velocity of about 100 to 150 m/s.

The combustible phase is ignited by any known means in the region where the fuel and the helical phase are in contact.

Thereafter, the flow imposed on the gases in the narrow passage takes place along a number of paths coincident with families of generatrices of a hyperboloid. These generatrices are based on a family of small-sized circles or rings located close to and below the narrow passage, before diverging in all directions.

Next, the mixture to be treated in liquid form is introduced via the aforementioned pipe. The liquid is then divided into a multitude of drops, each drop being transported by a volume of gas and subjected to a motion creating a centrifugal affect. Usually, the flow rate of the liquid is between 0.03 and 10 m/s.

The ratio of the proper momentum of the helical phase and that of the liquid mixture must be high. In particular, it is at least 100 and preferably between 1000 and 10 000. The momenta in the narrow passage are calculated based on the input flow rates of the gas and of the mixture to be treated, and also on the cross section of said passage. Increasing the flow rates increases the size of the drops.

Under these conditions, the proper motion of the gases is imposed both in its direction and its intensity, on the drops of the mixture to be treated, these being separated from one another in the region of convergence of the two streams. The velocity of the liquid mixture is, in addition, reduced to the minimum needed to obtain a continuous flow.

The spray drying is generally carried out with a solid output temperature between 100° C. and 300° C.

The final step of the method consists in calcining the product obtained from the drying.

In the case of preparing the precursor, the calcination is carried out at a temperature of at most 950° C. The lower limit of the calcination temperature may be fixed, on the one hand as a function of the temperature needed to obtain the compound of the invention in an essentially transition alumina crystallized form or, on the other hand as a function of the temperature at which there are no longer any volatile species in the compound at the end of the calcination, these species possibly deriving from the compounds of the elements used in the first step of the method. Furthermore, above 950° C. the aluminate compound of the invention is then obtained. By way of example and taking into account the above considerations, the calcination temperature is thus generally between 700° C. and 950° C., more particularly between 700° C. and 900° C.

The duration of the calcination is chosen to be long enough to obtain the product in the essentially transition alumina crystallized form or to remove the aforementioned volatile species. Thus it may be, for example, between 10 minutes and 5 hours and it is shorter the higher the calcination temperature.

The calcination is generally carried out in air.

The precursor compound of the invention is obtained at the end of this calcination. It should be noted that it is in the form of fine particles having an average diameter given above and that it is therefore not necessary, at the end of the calcination, to carry out a grinding operation. A deagglomeration operation may optionally be carried out under gentle conditions.

The aluminate compound is obtained at the end of an additional calcination step of the precursor as prepared by the method that has just been described.

This calcination must be carried out at high enough temperature so that the product that results therefrom has in particular the desired structure, that is to say the tridymite-, β-, magnetoplumbite- or garnet-type alumina structure and/or has sufficient luminescence properties. Generally this temperature is at least 950° C., more particularly at least 1050° C. In order to obtain an aluminate compound in the form of a pure β-type alumina phase, the calcination temperature may be at least 1200° C., it may more particularly be between 1200° C. and 1700° C.

This calcination may be carried out in air or, preferably when it is desired to obtain a phosphor, in a reducing atmosphere, for example in hydrogen mixed with nitrogen. The europium thus changes to the oxidation state 2.

The duration of the calcination is chosen, here too, to be long enough to obtain the product in the desired crystallized form and as a function of the required level of luminescence properties. For example, this duration may be between 30 minutes and 10 hours, it may more particularly be between 1 and 3 hours, for example about 2 hours.

Here too, at the end of the calcination, the aluminate compound is in the form of fine particles having an average diameter given above. A grinding operation is therefore not necessary, a deagglomeration operation may also possibly be carried out under gentle conditions.

This calcination may be carried out with or without a flux. As examples of suitable fluxes, mention may in particular be made of lithium fluoride, aluminum fluoride, magnesium fluoride, lithium chloride, aluminum chloride, magnesium chloride, potassium chloride, ammonium chloride and boron oxide, this list of course not being in any way exhaustive. The flux is mixed with the product, then the mixture is heated to the chosen temperature.

An aluminate having the same morphology as the precursor compound of the invention may be obtained by calcining without flux or else a product in the form of platelets may be obtained by calcining with a flux in the case of products having a β-alumina structure.

According to another embodiment of the invention, the aluminate compound may be obtained by a method that differs from that which has just been described by the calcination step. Thus, instead of carrying out a calcination in two steps, it is possible to directly prepare the aluminate compound by calcining the product resulting from the spray drying at a high enough temperature to produce the desired type of alumina structure and/or luminescence properties for said compound.

This calcination may be carried out by gradually increasing the temperature until the desired temperature value is reached, as described above, for example 1050° C. or 1200° C. The calcination may here too be carried out in air or, at least partially even completely, under a reducing atmosphere.

The aluminates thus obtained may be used as phosphors. Thus, they may be used in the manufacture of any device that incorporates phosphors such as plasma display screens or field-emission (microtip) display screens, trichromatic lamps, lamps for backlighting liquid crystal display screens, plasma excitation lamps and light-emitting diodes. As examples of the aforementioned products, it is possible to use in trichromatic and backlight lamps those of formula: Ba_{0.9}M²_{0.1}MgAl₁₀O₁₇; Ba_{0.9}M²_{0.1}Mg_{0.8}Mn_{0.2}Al₁₀O₁₇; Ba_{0.8}M²_{0.2}Mg_{1.93}Mn_{0.07}Al₁₆O₂₇. For plasma display screens or lamps Ba_{0.9}M²_{0.1}MgAl₁₀O₁₇ is especially suitable, M² being defined as before.

Finally, the invention relates to plasma display screens or field-emission (microtip) display screens, trichromatic lamps, lamps for backlighting liquid crystal display screens, plasma excitation lamps and light-emitting diodes comprising these aluminates as phosphors.

In the manufacture of the devices described above, these phosphors are applied using well-known techniques, for example by screen printing, electrophoresis or sedimentation.

Nonlimiting examples will now be given.

In these examples, the following measurement methods were employed.

### Analysis of the Carbon and Sulfur Contents

An LECO CS 444 analyzer was used to determine, simultaneously, the total carbon content and the overall sulfur content by a technique involving combustion in an induction furnace in oxygen and detection by an infrared system.

The sample (standard or unknown) is introduced into a ceramic crucible in which a LECOCEL-type accelerator and an IRON-type flux (during analysis of unknown samples) are added. The sample is melted at a high temperature in the furnace, the combustion gases are filtered over a metal gauze and then they pass over a series of reactants. At the outlet of the moisture trap, the SO₂ is detected using a first infrared cell. The gases then flow through a catalyst (platinized silica gel) which converts the CO into CO₂ and the SO₂ into SO₃. The latter is trapped by cellulose and the CO₂ is detected using two infrared cells.

### Analysis of the Nitrogen Content

An LECO TC-436 analyzer was used to determine the nitrogen content by a technique that involves melting in a resistance heating furnace. The nitrogen content is measured by thermal conductivity.

The analysis is carried out in two stages:
degassing the empty crucible:
   An empty graphite crucible is placed between the two electrodes of the furnace. A stream of helium purges the crucible of the atmospheric gases and isolates it therefrom. A large electric current is applied through the crucible, this having the effect of heating the latter to very high temperatures.
analysis of the sample:
   The weighed sample, introduced into the loading head, drops into the degassed empty crucible. A further application of a strong electric current through the crucible results this time in the sample being melted.

The nitrogen is then detected by a thermal conductivity cell.

### Laser Diffraction Particle Size Analysis

The measurements are made on a Coulter LS 230 light diffraction analyzer (standard module) combined with a 450 W (power 7) ultrasonic probe. The samples are prepared in the following manner: 0.3 g of each sample is dispersed in 50 ml of purified water. The suspension thus prepared is subjected to ultrasound for 3 minutes. One aliquot part of the suspension as is and deagglomerated is introduced into the vessel so as to obtain correct obscuration. For these measurements, the optical model used is: n=1.7 and k=0.01.

### COMPARATIVE EXAMPLE 1

This example relates to the preparation of a barium magnesium aluminate phosphor of formula Ba_{0.9}Eu_{0.1}MgAl₁₀O₁₇.

The raw materials used were a boehmite sol (specific surface area of 265 m²/g) containing 0.157 mol of Al per 100 g of gel, a 99.5% barium nitrate, a 99% magnesium nitrate and a europium nitrate solution containing 2.102 mol/l of Eu (d=1.5621 g/ml). 200 ml of boehmite sol were prepared (i.e. 0.3 mol of Al). Moreover, the salt solution (150 ml) contained 7.0565 g of Ba(NO₃)₂; 7.9260 g of Mg(NO₃)₂ and 2.2294 g of the Eu(NO₃)₃ solution. The final volume was made up to 405 ml (i.e. 2% of Al) with water. After mixing the sol with the salt solution, the final pH was 3.5. The suspension obtained was spray-dried in a spray dryer of the type described in European patent application 0 007 846 with an outlet temperature of 240° C. The dried power was calcined at 900° C. for 2 hours in air. In a second step, the powder was calcined at 1500° C. for 2 hours in 3% hydrogenated argon.

### EXAMPLE 2

This example relates to the preparation of a barium magnesium aluminate phosphor of formula Ba_{0.89}Eu_{0.1}Y_{0.01}MgAl₁₀O₁₇. The method of example 1 was followed by using, in addition, yttrium nitrate Y(NO₃)₃, introduced in a stoichiometric amount, as an additional raw material.

### EXAMPLE 3

This example relates to the preparation of a barium magnesium aluminate phosphor of formula Ba_{0.89}Eu_{0.1}Yb_{0.01}MgAl₁₀O₁₇. The method of example 1 was followed but using, in addition, ytterbium nitrate Yb(NO₃)₃, introduced in a stoichiometric amount, as an additional raw material.

### Characterization of the Products

### A) Products Calcined at 900° C.

These products were therefore precursors according to the meaning of the description.

The precursors from examples 1, 2 and 3 were formed from spherical particles that had a d₅₀ of 2.8 μm and a dispersion index of 0.6.

These products had a γ-alumina structure. The X-ray diagram of FIG. 1 corresponds to the product from example 2. The SEM photograph of FIG. 3 clearly shows the spherical appearance of the particles forming the product from this same example 2.

The precursor from example 2 had a nitrogen content of 0.39%, a sulfur content of less than 0.01% and a carbon content of 0.09%.

### B) Products Calcined at 1500° C.

These products were therefore the aluminate compounds according to the meaning of the description.

The three products had spherical particles, a d₅₀ of 3.5 μm and a dispersion index of 0.6. FIG. 4 is a SEM photograph of the product obtained in example 2. The products had a β-type alumina structure (FIG. 2 XRD) and they emitted a blue emission under UV or VUV excitation, the emitter being Eu²⁺ (emission at 450 nm).

The luminescence was also measured for the product from example 1 and that of example 3 for a VUV excitation (173 nm). This luminescence was measured by the area under the curve of the emission spectrum between 380 nm and 650 nm. The value obtained for the product from example 1 was 100 and it was 104 for the product from example 3. The product according to the invention therefore had an improved luminescence under VUV excitation.

### C) Products After Heat Treatment

A heat treatment was then carried out on the three aluminate compounds from the examples, at 600° C. for 2 hours in air. The following table shows the change in the photoluminescence (PL) efficiencies before and after this heat treatment.

The luminescence efficiencies were measured from the emission spectrum of the products. This spectrum gave the emission intensity under an excitation at 254 nm as a function of the wavelength values between 350 nm and 700 nm. A relative efficiency was measured that corresponds to the area under the curve of the spectrum and that is set at a base of 100 for the comparative product before the heat treatment.

| | PL (before heat | PL (after heat |
|---|---|---|
| Example | treatment) | treatment) |
| 1 comparative | 100 | 65 |
| 2 | 98 | 98 |
| 3 | 98 | 98 |

No degradation of the luminescence was observed after the heat treatment in the case of the products of the invention.

1-27. (canceled)

28. An alkaline-earth metal aluminate compound, at least partially crystallized in the form of a β-type alumina, having a composition corresponding to the formula:
a(M¹O).b(MgO).c(Al₂O₃) (1)
wherein M¹ denotes at least one alkaline-earth metal and a, b and c are integers or non-integers satisfying the relationships:
0.25≦a≦4; 0≦b≦2 and 0.5≦c≦9;
M¹ is partially substituted with europium and at least one other element belonging to the group of rare-earth elements whose ionic radius is less than that of Eu³⁺, and being in the form of substantially whole particles with an average size of at most 6 μm.

29. The compound as claimed in claim 28, being crystallized in a pure β-type alumina phase.

30. An alkaline-earth metal aluminate precursor compound, having a composition corresponding to the formula:
a(M¹O).b(MgO).c(Al₂O₃) (1)
wherein M¹ denotes at least one alkaline-earth metal and a, b and c are integers or nonintegers satisfying the relationships:
0.25≦a≦4; 0≦b≦2 and 0.5≦c≦9;
M¹ is partially substituted with europium and at least one other element belonging to the group of rare earth elements whose ionic radius is less than that of Eu³⁺, and being in the form of particles with an average size of at most 15 μm.

31. The compound as claimed in claim 30, being in the form of particles with an average size of at most 10 μm, optionally of at most 6 μm.

32. The compound as claimed in claim 30, being in the form of substantially whole particles.

33. The compound as claimed in claim 30, being crystallized predominantly in the form of a transition alumina.

34. The compound as claimed in claim 30, being in the form of substantially spherical particles.

35. The compound as claimed in claim 30, being in the form of particles whose pores have an average diameter of at least 10 nm.

36. The compound as claimed in claim 28, wherein the other aforementioned element is gadolinium, terbium, ytterbium or yttrium.

37. The compound as claimed in claim 28, having an amount of europium and of the other aforementioned element, expressed as the atomic percentage (Eu+other element)/(M¹+Eu+other element), of at most 30%.

38. The compound as claimed in claim 28, in claim 28 an amount of the other aforementioned element, expressed as the atomic percentage other element/Eu of at most 50%.

39. The compound as claimed in claim 28, corresponding to the formula (1), M¹ denoting barium, strontium, calcium or a combination of barium and strontium.

40. The compound as claimed in claim 28, corresponding to the formula (1) in which a, b and c satisfy the relationships:
0.25≦a≦2; 0≦b≦2 and 3≦c≦9 and
M¹ being barium.

41. The compound as claimed in claim 28, corresponding to the formula (1) in which a=b=1 and c=5 or 7, and M¹ being barium.

42. The compound as claimed in claim 28, corresponding to the formula (1) in which a=1, b=2, c=8, and M¹ being barium.

43. The compound as claimed in claim 28, wherein the magnesium is partially substituted with at least one element being zinc, cobalt or manganese.

44. The compound as claimed in claim 28, wherein the aluminum is partially substituted with gallium, scandium, boron, germanium or silicon.

45. The compound as claimed in claim 28, wherein the particles have an average diameter between 1.5 μm and 6 μm.

46. The compound as claimed in claim 28, being in the form of particles that have a dispersion index of at most 0.7.

47. The compound as claimed in claim 28, having a nitrogen content of at most 1% nitrogen, optionally of at most 0.6%.

48. The compound as claimed in claim 28, having a carbon content of at most 0.5%, optionally of at most 0.2%.

49. A method for preparing a precursor compound as claimed in claim 30, comprising the steps of:
a) forming a liquid mixture consisting of the aluminum, M¹ and magnesium compounds and the compounds of their substituents;
b) drying said mixture by spray drying; and
c) calcining the dried product at a temperature of at most 950° C.

50. A method for preparing a crystallized compound as claimed in claim 28, comprising the steps of:
a) forming a liquid mixture consisting of the aluminum, M¹ and magnesium compounds and compounds of their substituents;
b) drying said mixture by spray drying;
c) calcining the dried product at a temperature of at most 950° C.; and
c) calcining the product resulting from the preceding step again at a high enough temperature to produce the tridymite-, β-, magnetoplumbite- or garnet-type alumina structure and/or luminescence properties for said compound, this calcination optionally being conducted under a reducing atmosphere.

51. The method as claimed in claim 50, wherein the aluminum compound is an aluminum sol.

52. A plasma display screen or field-emission (microtip) display screen, comprising, as a phosphor, an alkaline-earth metal aluminate compound as claimed in claim 28.

53. A trichromatic lamp, liquid crystal display backlight lamp or plasma excitation lamp comprising, as a phosphor, an alkaline-earth metal aluminate as claimed in claim 28.

54. A light-emitting diode, comprising, as a phosphor, an alkaline-earth metal aluminate as claimed in claim 28.
